(19) United States
(12) Patent Application Publication
(10) Pub. No.: US 2020/0076983 A1
(43) Pub. Date: Mar. 5, 2020

(54) INFORMATION PROCESSING APPARATUS, DISPLAY METHOD IN INFORMATION PROCESSING APPARATUS, AND RECORDING MEDIUM

(71) Applicant: SHARP KABUSHIKI KAISHA, Sakai City (JP)

(72) Inventors: AKINORI OHNISHI, Sakai City (JP); HIROKI MUNETOMO, Sakai City (JP); RYOHJI MURATA, Sakai City (JP)

(21) Appl. No.: 16/556,039

(22) Filed: Aug. 29, 2019

(30) Foreign Application Priority Data
Sep. 5, 2018 (JP) 2018-165853

(51) Int. Cl. H04N 1/327; H04N 1/00; H04N 1/32

(52) U.S. Cl. CPC H04N 1/32771; H04N 1/00413; H04N 2201/0094; H04N 1/0097; H04N 1/32523

(57) ABSTRACT

An information processing apparatus includes a communication device and a controller. The controller searches for image forming apparatuses in a network via the network communication device, specifies the image forming apparatus among the searched image forming apparatuses, the former image forming apparatus providing file sharing service, and displays a list of file sharing folders in the specified image forming apparatus.

### BACKGROUND

### 1. Field

The present disclosure relates to an information processing apparatus, etc.

### 2. Description of the Related Art

An image forming apparatus has hitherto been known which provides file sharing service and which has a shared folder prepared in a storage device.

An image forming apparatus disclosed in Japanese Unexamined Patent Application Publication No. 2002-2028, for example, includes a hard disk drive (HDD) storing image data. A shared folder is prepared in the HDD, and the shared folder is used to send and receive image data via a LAN to and from a personal computer for which another operator is in charge.

However, when a user accesses the shared folder in the image forming apparatus, the user is asked to get connection information for an access to the shared folder and to set the connection information. In other words, the user is demanded to recognize which one among image forming apparatuses disposed in a network provides file sharing service, and to make setting by himself or herself.

In consideration of the above-described situation, it is desirable to provide an information processing apparatus, etc., which can display a file sharing folder in an image forming apparatus connected to a network without resorting to setting by a user.

### SUMMARY

According to one aspect of the disclosure, there is provided an information processing apparatus including a communication device and a controller, wherein the controller searches for image forming apparatuses in a network via the communication device, specifies the image forming apparatus among the searched image forming apparatuses, the former image forming apparatus providing file sharing service, and displays a list of file sharing folders in the specified image forming apparatus.

According to another aspect of the disclosure, there is provided a display method in an information processing apparatus equipped with a communication device, the display method including searching for image forming apparatuses in a network via the communication device, specifying the image forming apparatus among the searched image forming apparatuses, the former image forming apparatus providing file sharing service, and displaying a list of file sharing folders in the specified image forming apparatus.

According to still another aspect of the disclosure, there is provided a non-transitory recording medium storing a program in accordance with which a computer implements functions of searching for image forming apparatuses in a network, specifying the image forming apparatus among the searched image forming apparatuses, the former image forming apparatus providing file sharing service, and displaying a list of file sharing folders in the specified image forming apparatus.

### BRIEF DESCRIPTION OF THE DRAWINGS

FIG. 1 is an explanatory view of an overall system in a first embodiment;

FIG. 2 is a block diagram referenced to explain a configuration of a terminal apparatus in the first embodiment;

FIG. 3 is a block diagram referenced to explain a configuration of a multifunction peripheral in the first embodiment;

FIG. 4A is an explanatory view representing a structure of a shared folder in the first embodiment;

FIG. 4B is an explanatory view representing the structure of the shared folder in the first embodiment;

FIG. 5 is a flowchart referenced to explain the operation of a file management process in the first embodiment;

FIG. 6 is a flowchart referenced to explain the operation of a multifunction-peripheral registration process in the first embodiment;

FIG. 7 is a flowchart referenced to explain the operation of a multifunction-peripheral tree display process in the first embodiment;

FIG. 8A is an explanatory view representing an operation example (screen example) in the first embodiment;

FIG. 8B is an explanatory view representing an operation example (screen example) in the first embodiment;

FIG. 9A is an explanatory view representing the operation example (screen example) in the first embodiment;

FIG. 9B is an explanatory view representing as operation example (screen example) in the first embodiment;

FIG. 10A is an explanatory view representing an operation example (screen example) in the first embodiment;

FIG. 10B is an explanatory view representing an operation example (screen example) in the first embodiment; and

FIG. 11 is a flowchart referenced to explain the operation of a multifunction-peripheral registration process in a fourth embodiment.

### DESCRIPTION OF THE EMBODIMENTS

Embodiments of the present disclosure will be described below with reference to the drawings. The following embodiments are merely illustrative with intent to explain examples of the present disclosure, and the technical scope of the present disclosure defined in Claims is not limited by the following description.

### 1. First Embodiment

### 1.1 System Configuration

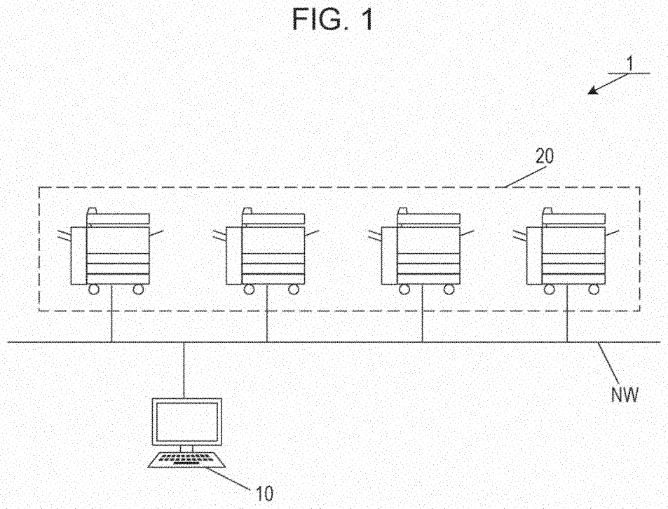

FIG. 1 is an explanatory view of an overall system 1 in a first embodiment. In the system 1, a terminal apparatus 10, also called an information processing apparatus, and a multifunction peripheral (MFP) 20 (image forming apparatuses), also called an image processing apparatus, are connected to a network NW via individual networks.

One or more units of various apparatuses are connected to the network NW. In particular, multiple units of the multifunction peripherals 20 are connected to the network NW.

The terminal apparatus 10 is, for example, a computer, i.e., an information processing apparatus. In another example, the terminal apparatus 10 may be tablet terminal or a smartphone. In still another example, a server apparatus may be separately connected, and the terminal apparatus 10 may be provided as an ASP (Application Service Provider) tool in accordance with execution of the server apparatus.

The multifunction peripheral (MFP) 20 is an image processing apparatus with multiple functions and it functions, for example, as a copying machine, a printing device (printer), a facsimile, and a scanner. The multifunction peripheral is further called a digital multifunction peripheral, etc.

As the multifunction peripherals in the system 1, there are two types, namely the multifunction peripherals made by makers who are service targets and the multifunction peripherals made by makers who are not service targets. The multifunction peripherals made by the same maker are further divided into two types, namely the multifunction peripherals adapted for the service and the multifunction peripherals not adapted for the service.

In the following description, the service provided in this embodiment is assumed to be file sharing service, for example. Moreover, the following description is made in connection with an example using, as the image processing apparatus, the multifunction peripheral 20 that is the image forming apparatus, but the present disclosure can also be applied to an apparatus implementing the function of a scanner, a printer, a FAX, or the like alone.

### 1.2 Apparatus Configurations

Configurations of individual apparatuses included in the system 1 will be described below with reference to the drawings. The apparatus configurations described below are merely illustrative, and the apparatuses may be configured on the case-by-case basis.

### 1.2.1 Terminal Apparatus

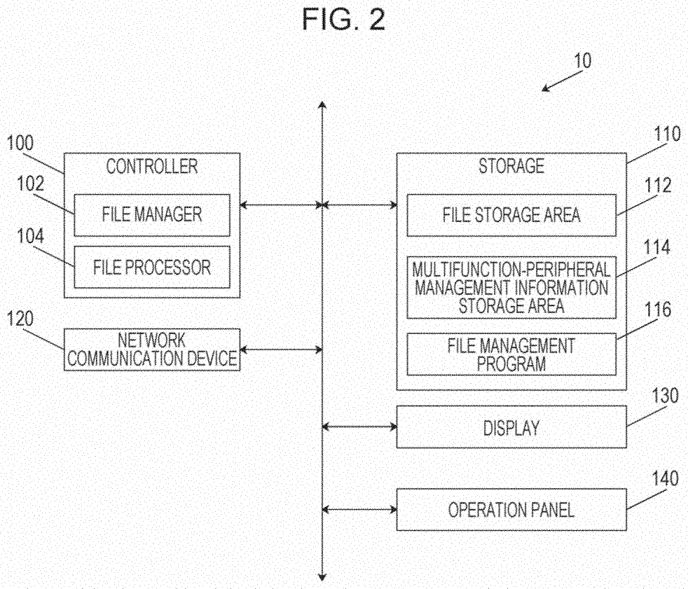

FIG. 2 illustrates a configuration of the terminal apparatus 10. The terminal apparatus 10 includes a controller 100, a storage 110, a network communication device 120, a display 130, and an operation panel 140.

The controller 100 controls the entirety of the terminal apparatus 10. The controller 100 implements various functions by reading and executing various programs stored in the storage 110, and it is constituted by one or more arithmetic units (e.g., CPUs (Central Processing Units)).

Furthermore, the controller 100 functions as a file manager 102 and a file processor 104 by reading the programs out of the storage 110 and executing them.

The file manager 102 implements the function of managing files by reading and executing a file management program stored in the storage 110. The file manager 102 executes various processes such as displaying a list of files in a folder (shared folder) and assigning a shared folder in another apparatus in a manner of making the shared folder accessible.

The file processor 104 implements the function of executing various processes on files. For example, the file processor 104 can copy, delete, or move files, change file names, and actually open files.

The storage 110 is a function unit storing various programs used to operate the terminal apparatus 10, and various data. The storage 110 is constituted by, for example, an SSD (Solid State Drive) that is a semiconductor memory, or a HDD (Hard Disk Drive) that is a magnetic disk. Alternatively, the storage 110 may be an external storage device connected through a USB (Universal Serial Bus), for example, or may be given as a cloud area accessible via a network.

In addition, a file storage area 112 capable of storing various files and a multifunction-peripheral management information storage area 114 are prepared in the storage 110. The storage 110 further stores a file management program 116.

The file storage area 112 can store various files such as a user's sentence file, a data file, and an image file. For example, the controller 100 can send a file stored in the file storage area 112 to the multifunction peripheral 20 and can store a file received from the multifunction peripheral 20 in the file storage area 112. The file stored in the file storage area 112 is called a “local file” in some cases.

The multifunction-peripheral management information storage area 114 stores multifunction-peripheral management information, i.e., information used to manage the multifunction peripherals. The multifunction-peripheral management information includes information regarding the performance and available services for each of the multifunction peripherals, information used by the file manager 102, etc.

For example, the functions, the available services, the options, etc. of each multifunction peripheral 20 can be managed in correspondence to a predetermined identification value (here, an apparatus identification value contained in a later-described MIB value). Other information regarding the multifunction peripherals can also be stored in the multifunction-peripheral management information storage area 114.

The multifunction-peripheral management information may be stored in advance or may be stored by the user. Alternatively, the multifunction-peripheral management information may be obtained from an external server and then stored.

The file management program 116 is a program capable of implementing file management. Later-described various processes are implemented by the controller 100 reading and executing the file management program 116.

The network communication device 120 performs communication with the other devices, the multifunction peripherals, and a server apparatus via the network NW. The network may be connected by wire or wirelessly. Moreover, the network communication device 120 may be connected to an access point by utilizing a wireless LAN (WLAN) and then connected to the network NW. This embodiment is described, by way of example, in connection with the case of using a general LAN (Local Area Network), but a WAN such as LTE (Long Term Evolution)/4G/5G communication may also be utilized.

The display 130 can display various types of information and can be constituted by such a device as an LCD (Liquid Crystal Display) or an organic EL display. The operation panel 140 accepts an operation input from the user. For example, the operation panel 140 may be constituted by a hardware key or a software key, or by an external input device such as a keyboard or a mouse. Alternatively, the display 130 and the operation panel 140 may be integrally constituted in the form of a touch panel.

### 1.2.2 Multifunction Peripheral

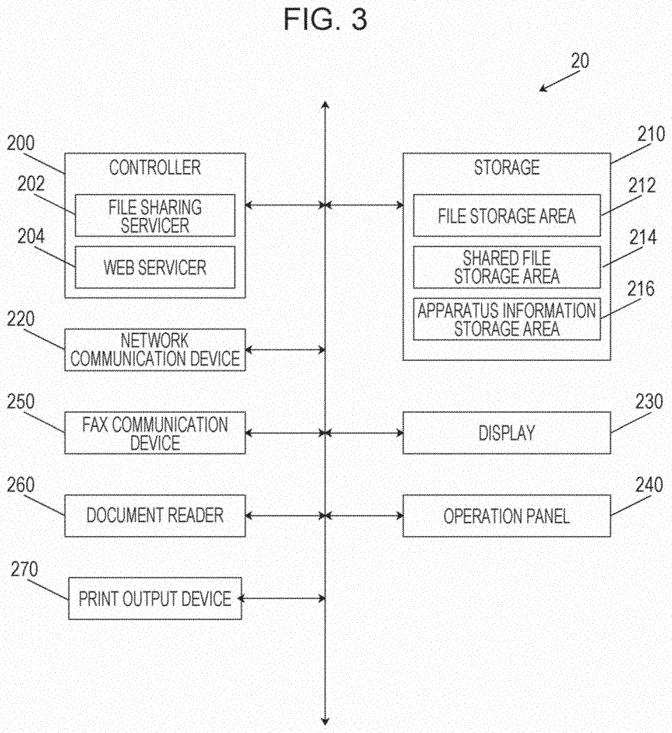

The configuration of the multifunction peripheral 20 will be described below with reference to FIG. 3. The multifunction peripheral 20 includes a controller 200, storage 210, a network communication device 220, a display 230, an operation panel 240, a FAX communication device 250, a document reader 260, and a print output device 270.

The controller 200 controls the entirety of the multifunction peripheral 20. The controller 200 implements various functions by reading and executing various programs stored in the storage 210, and it is constituted by one or more arithmetic units (e.g., CPUs (Central Processing Units)).

Furthermore, the controller 200 functions as a file sharing servicer 202 and a WEB servicer 204 by reading and executing the programs stored in the storage 210.

The file sharing servicer 202 provides the file sharing service. For example, the file sharing servicer 202 provides, to the terminal apparatus 10 that has passed terminal authentication or a user who has passed user authentication, service allowing the relevant terminal apparatus 10 or the user to access a file stored in the shared file storage area 214. The file stored in the shared file storage area 214 is called a “shared file” in some cases.

The WEB servicer 204 provides WEB service to another apparatus. In response to an access from another apparatus, for example, the WEB service provides a setting screen, etc. as a WEB page. In this embodiment, the WEB servicer 204 can make setting of permission/prohibition of the shared folder provided by the file sharing servicer 202. In addition, the WEB servicer 204 can further provide, as a WEB page, a screen on which various settings of the multifunction peripheral 20 can be made.

The storage 210 is a function unit storing various programs used to operate the multifunction peripheral 20, and various data. The storage 210 is constituted by, for example, an SSD (Solid State Drive) that is a semiconductor memory, or a HDD (Hard Disk Drive) that is a magnetic disk. Alternatively, the storage 210 may be an external storage device connected through a USB (Universal Serial Bus), for example, or may be given as a cloud area accessible via a network.

In addition, a file storage area 212 and a shared file storage area 214 are prepared in the storage 210 as areas capable of storing various files. The storage 210 further stores apparatus information, i.e., information regarding the multifunction peripheral 20, in the apparatus information storage area 216.

For example, such items as the maker name, model number, option information, apparatus status, and available services of the multifunction peripheral, are stored as the apparatus information. The apparatus information is utilized as, for example, information of a MIB (Management Information Base) in an SNMP (Simple Network Management Protocol). In an example, the apparatus information for specifying the multifunction peripheral is contained as an apparatus identification value in the MIB.

The file storage area 212 and the shared file storage area 214 can store various files such as a user's sentence file, a data file, and an image file. For example, the controller 200 stores a document file received from the terminal apparatus 10 via the network communication device 220. Furthermore, the controller 200 may store an image file received by the FAX communication device 250 and an image file of document image data read by the document reader 260.

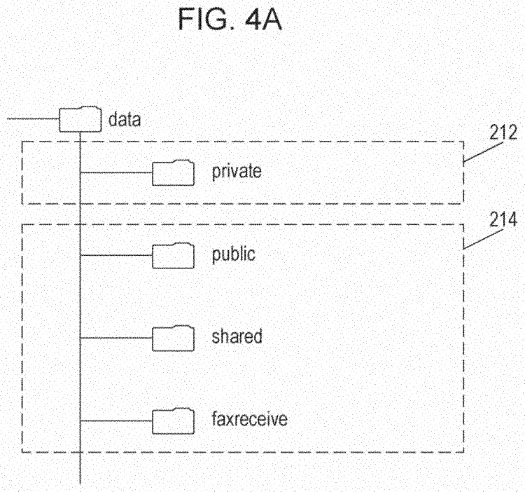

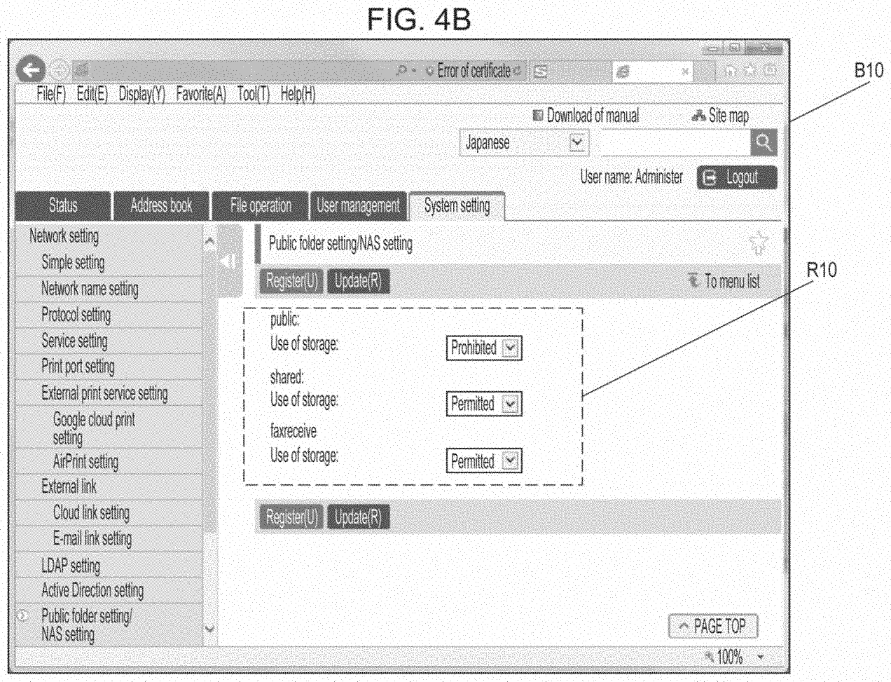

Here, the file stored in the shared file storage area 214 can be accessed as the shared file from the terminal apparatus 10. The word “access” implies an operation of reading, writing, or deleting a file. The wording “accessible to a folder” implies an ability of not only reading files stored (loaded) in the folder or displaying a list of the files, but also forming or deleting a subfolder or changing the name of a subfolder. The file storage area 212 and the shared file storage area 214 will be described below with reference to FIGS. 4A and 4B.

FIG. 4A is a schematic view referenced to explain a folder structure (directory structure) in the storage 210. For example, a subfolder corresponding to the file storage area 212 and a subfolder corresponding to the shared file storage area 214 are included in a folder called “data”.

For example, the file storage area 212 is constituted by a folder “private”. This folder functions as the file storage area 212 upon a file being stored therein. The shared file storage area 214 is constituted by folders “public”, “shared”, and “faxreceive”. Those folders are accessible from other apparatuses and can store or read files in or from the other apparatuses.

The shared file storage area 214 is set in the multifunction peripheral 20, for example. FIG. 4B illustrates, by way of example, a browser screen B10 displayed by a browser in the terminal apparatus 10. The browser screen B10 is displayed by, for example, entering an IP address of the multifunction peripheral 20 in accordance with the browser of the terminal apparatus 10.

In an area R10, information indicating permission or prohibition of utilization for each folder (shared folder) is set. Thus, whether the utilization is “PERMITTED” or “PROHIBITED” can be set in the area R10 for each of the folders “public”, “shared”, and “faxreceive”.

The apparatus information storage area 216 stores the apparatus information, i.e., the information regarding the multifunction peripheral 20. The apparatus information includes, for example, specific information of the multifunction peripheral 20 and setting information set by the user or the administrator.

The specific information includes not only information such as the manufacturer name, model name, series name, and production number of the multifunction peripheral 20, but also information regarding the types of equipped units and options, etc. The setting information includes information that can be set in the multifunction peripheral 20 by the user or the administrator, namely information regarding the presence or absence of available various services, information of the shared folder, information of printing conditions, network setting information such as an IP address, the sizes and types of paper sheets, etc.

The network communication device 220 performs communication with the other devices and apparatuses and the server apparatus via the network NW. The network may be connected by wire or wirelessly. Moreover, the network communication device 220 may be connected to an access point by utilizing a wireless LAN (WLAN) and then connected to the network NW. This embodiment is described, by way of example, in connection with the case of using a general LAN (Local Area Network), but a WAN such as LTE (Long Term Evolution)/4G/5G communication may also be utilized.

The display 230 can display various types of information and can be constituted by such a device as an LCD (Liquid Crystal Display) or an organic EL display. The operation panel 240 accepts an operation input from the user. For example, the operation panel 240 may be constituted by a hardware key or a software key, or by an external input device such a keyboard or a mouse. Alternatively, the display 230 and the operation panel 240 may be integrally constituted in the form of a touch panel.

The FAX communication device 250 implements the FAX function. For example, the FAX communication device 250 stores image data, which has been received via an ISDN line or an Internet line, in the file storage area 212 or the shared file storage area 214. The FAX communication device 250 may further send the file stored in the file storage area 212 or the shared file storage area 214 to another FAX machine.

The document reader 260 reads a document. More specifically, the document reader 260 is constituted by a scanner, and the read document is output as image data to the file storage area 212 or the shared file storage area 214.

The print output device 270 performs printing and outputting in accordance with a sentence file or image data. For example, the image data is output to printing paper. The print output device 270 is constituted by a laser printer, for example.

### 1.3 Processing Flow

Processes of reading a program from the storage 110 and executing the program by the controller 100 will be described below with reference to the drawings on a case-by-case basis.

### 1.3.1 File Management Process

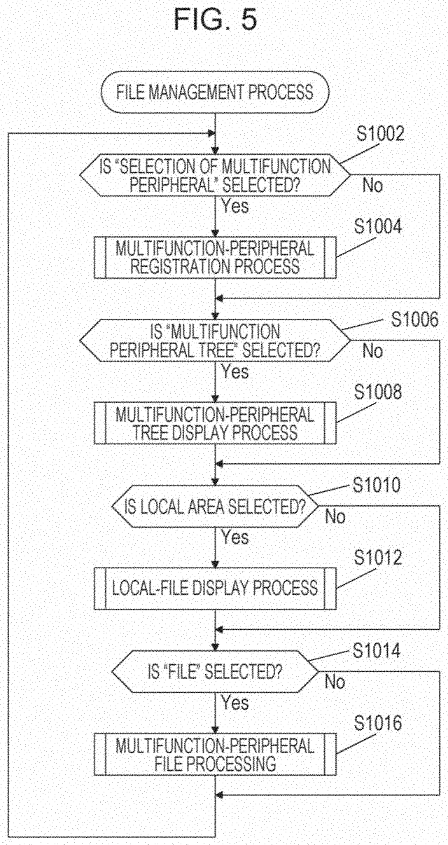

A file management process executed by the file manager 102 (in the controller 100) is described with reference to FIG. 5.

The file manager 102 executes a process corresponding to one selected from among various items. For example, when “Selection of multifunction peripheral” is selected by the user, the file manager 102 executes a multifunction-peripheral registration process (Step S1002; Yes→Step S1004).

When “Multifunction peripheral tree” is selected by the user, the file manager 102 executes a multifunction-peripheral tree display process (Step S1006; Yes→Step S1008).

When a local area is selected by the user, the file manager 102 executes a local-file display process (Step S1010; Yes→Step S1012).

The local-file display process is a process of displaying a list of the files stored in the file storage area 112 of the terminal apparatus 10 (i.e., the files in the local area of the terminal apparatus 10).

Thus, in the multifunction-peripheral tree display process, a list of the files stored in the shared file storage area 214 of the multifunction peripheral 20 is displayed. In the local-file display process, the list of the files stored in the file storage area 112 of the terminal apparatus 10 is displayed. When some folder is selected by the user at that time, a list of files stored in that folder is displayed.

Furthermore, when some file is selected by the user, the file processor 104 executes file processing (Step S1014; Yes→Step S1016).

Here, the file processing executed by the file processor 104 is to execute various types of file processing on the selected file.

The file processor 104 can execute various types of processing on the shared file. For example, the following processes are executed as the file processing.

Printing of file. The selected file is printed. The file may be printed directly or by launching a print dialog.

FAX transmission of file. When the shared file is selected, FAX transmission of the selected file is performed directly from the multifunction peripheral 20 in which the shared file is stored. When the local file is selected, a PC-FAX driver may be started for FAX transmission of the selected file.

Image processing on file (such as spot removal, automatic trimming, automatic skew correction, and automatic rotation.)

E-mail attachment process. In this case, for example, a mailer is started to present a mail sending screen. Thereafter, the selected file is attached to the E-mail.

Thus, the file processor 104 executes, during execution of the file management process, a process corresponding to an item selected by the user. In addition, for example, when some process (such as a setting process or a job process) is selected by the user, the controller 100 (specifically, the file manager 102) may execute the selected process. The following description is made about the processes representing the features of this embodiment.

### 1.3.2 Multifunction-Peripheral Registration Process

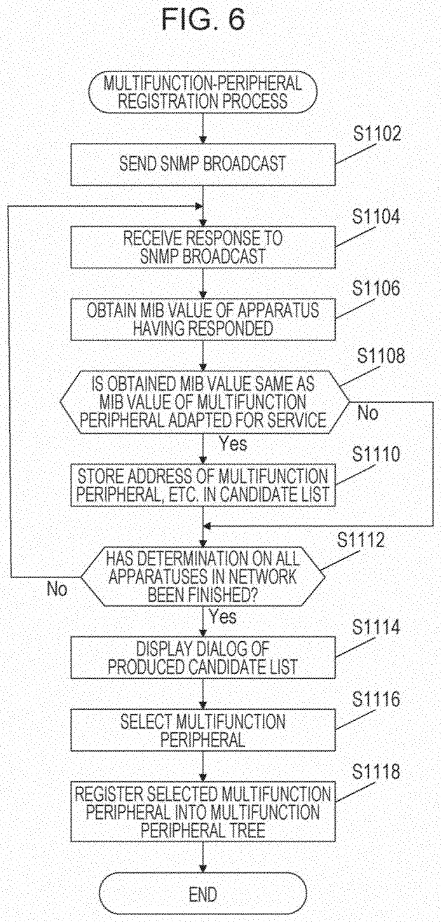

The multifunction-peripheral registration process executed in Step S1004 of FIG. 5 is described with reference to FIG. 6.

First, the controller 100 of the terminal apparatus 10 searches for the multifunction peripheral in the network. As a method of searching for the multifunction peripheral, the controller 100 sends an SNMP (Simple Network Management Protocol) broadcast via the network communication device 120 (Step S1102).

The controller 100 receives a response to the SNMP broadcast from another apparatus in the network via the network communication device 120 (Step S1104). Then, the controller 100 obtains an MIB (Management Information Base) value of the apparatus (e.g., the multifunction peripheral 20) that has responded upon. receiving the SNMP broadcast (Step S1106).

Then, the controller 100 determines whether the obtained MIB value is a MIB value of the multifunction peripheral adapted for the file sharing service (Step S1108).

More specifically, the controller 100 obtains, from the MIB value, an identification value to identify the apparatus. On the basis of the identification value, the controller 100 refers to the multifunction-peripheral management information and specifies the multifunction peripheral corresponding to the identification value (e.g., an apparatus identification value). In this embodiment, the controller 100 specifies, for example, the model number of the multifunction peripheral. Furthermore, the controller 100 refers to the multifunction-peripheral management information and determines whether the multifunction peripheral having the specified model number is the multifunction peripheral adapted for the file sharing service. The multifunction peripheral may also be specified by a manner using an item other than the model number, such as the maker name, the series name, or the group name, the item enabling the multifunction peripheral to be specified.

If the multifunction peripheral having the obtained MIB value is adapted for the file sharing service, the controller 100 stores an address (e.g., an IP address) of the relevant multifunction peripheral and information of the shared folder, which is provided by the file sharing service, in a candidate list (Step S1110).

The candidate list is a list storing the multifunction peripherals that are candidates to be registered in a multifunction peripheral tree described later. The candidate list may be stored in the storage 110 temporarily or as the multifunction-peripheral management information.

Then, the controller 100 determines whether the determination as for whether the multifunction peripheral is adapted for the file sharing service has been made for all the apparatuses connected to the network (Step S1112). As described later, all the apparatuses may be only the multifunction peripherals in the network or all types of apparatuses including a computer, a router, etc.

If it is determined that the determination for all the apparatuses is not yet finished, the controller 100 repeatedly executes the processing from Step S1104 (Step S1112; No→Step S1104).

If it is determined that the determination for all the apparatuses connected to the network has been finished, the controller 100 displays a dialog in accordance with the produced candidate list (Step S1114).

If the multifunction peripheral is selected by the user from the dialog displayed in accordance with the candidate list (Step S1116), the selected multifunction peripheral is registered into the multifunction peripheral tree (Step S1118). The multifunction peripheral tree may be stored as the multifunction-peripheral management information.

There are various methods of selecting the multifunction peripheral. For example, the user may register the multifunction peripheral into the multifunction peripheral tree by checking a check mark displayed in the candidate list. Alternatively, the user may select an icon of one of the multifunction peripherals displayed in the candidate list (for example, may select the icon by touching the same) such that the icon is displayed as having been identified. In the latter case, the multifunction peripheral corresponding to the icon di played as having been identified may be registered into the multifunction peripheral tree.

While, in the above description, the determination is executed in Step S1112 on all the apparatuses in the network, the determination may be executed on, for example, only those of the multifunction peripherals in the network, which are made by the own company providing the service. Furthermore, when a predetermined time has passed, the determination in Step S1112 may be resulted in “Yes”. In other words, if timed out, the candidate list may be displayed.

While, in the above description, the produced candidate list is displayed as the dialog in Step S1114, the candidate list may be displayed in a manner other than using the dialog insofar as the candidate list is displayed in a predetermined area.

In this embodiment, the dialog is once displayed in accordance with the candidate list, thus prompting the user to select the multifunction peripheral to be registered into the multifunction peripheral tree. In another example, the process may be modified to automatically register the multifunction peripheral, which is adapted for the file sharing service, into the multifunction peripheral tree.

### 1.3.3 Multifunction-Peripheral Tree Display Process

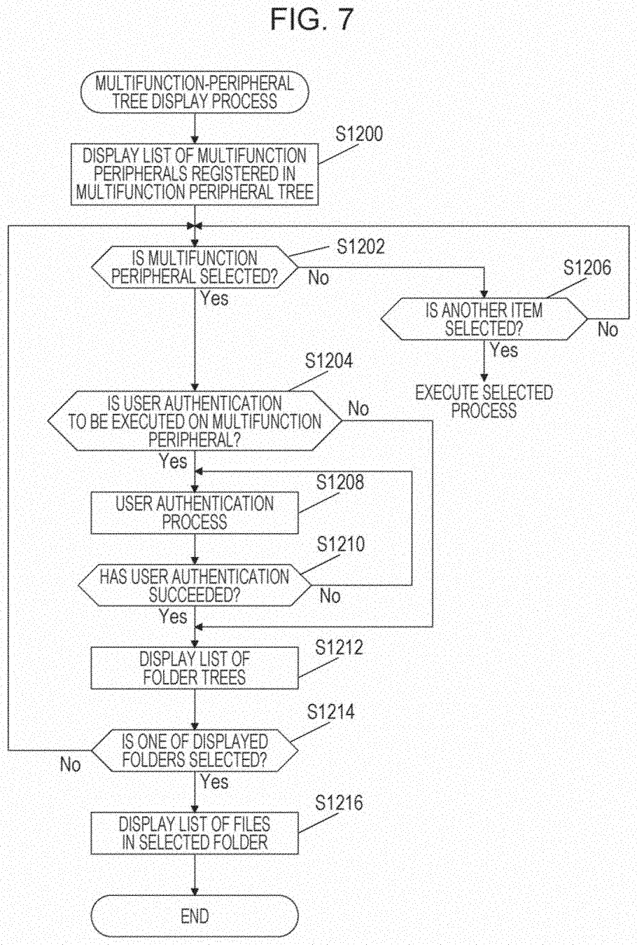

The multifunction-peripheral tree display process is described with reference to FIG. 7.

First, the controller 100 displays a list of the multifunction peripherals registered in the multifunction peripheral tree (Step S1200).

Then, if one of the multifunction peripherals displayed in the list is selected (Step S1202; Yes), the controller 100 determines whether a user authentication process is to be performed on the selected multifunction peripheral (Step S1204).

If the user authentication is to be performed on the selected multifunction peripheral (Step S1204; Yes), the controller 100 executes the user authentication process (Step S1208). For example, the controller 100 executes the user authentication process by prompting the user to input the user name and the password, or to do biometric authentication.

If the user authentication has succeeded (Step S1210; Yes), the controller 100 displays a list of folder trees in the selected multifunction. peripheral (Step S1212).

In the case of the multifunction peripheral for which it is originally assumed that the user authentication process is not to be executed, the controller 100 may display a list of folder trees in the selected multifunction peripheral without executing the user authentication (Step S1204; No→Step S1212).

If the user authentication has not succeeded, the controller 100 may repeatedly execute the user authentication process (Step S1210; No→Step S1208). In this case, if the user authentication has not succeeded even after executing the user authentication process a predetermined number of times, the controller 100 may end the ongoing process or may display the fact that the selection of the relevant multifunction peripheral is not allowed.

If some folder is selected by the user from the displayed folder tree (Step S1214; Yes), the controller 100 displays a list of files in toe selected folder (Step 1216).

If an item other than the multifunction peripheral is selected by the user in the state in which the multifunction peripheral tree is displayed, the controller 100 may execute a different process from the above-described one in accordance with the selected item (Step S1202; No→Step S1206; Yes).

### 1.4 Operation Example

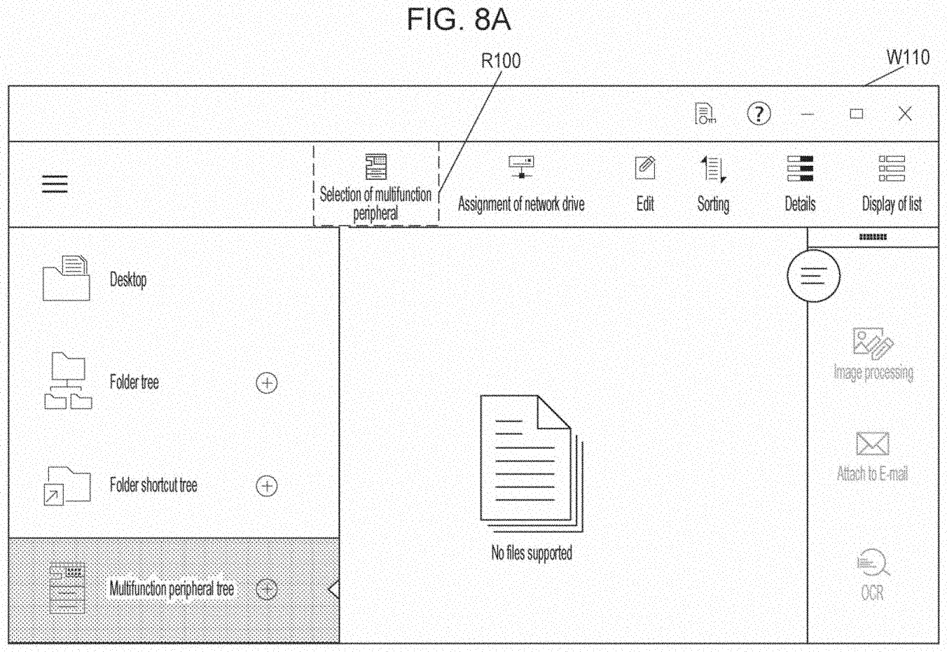

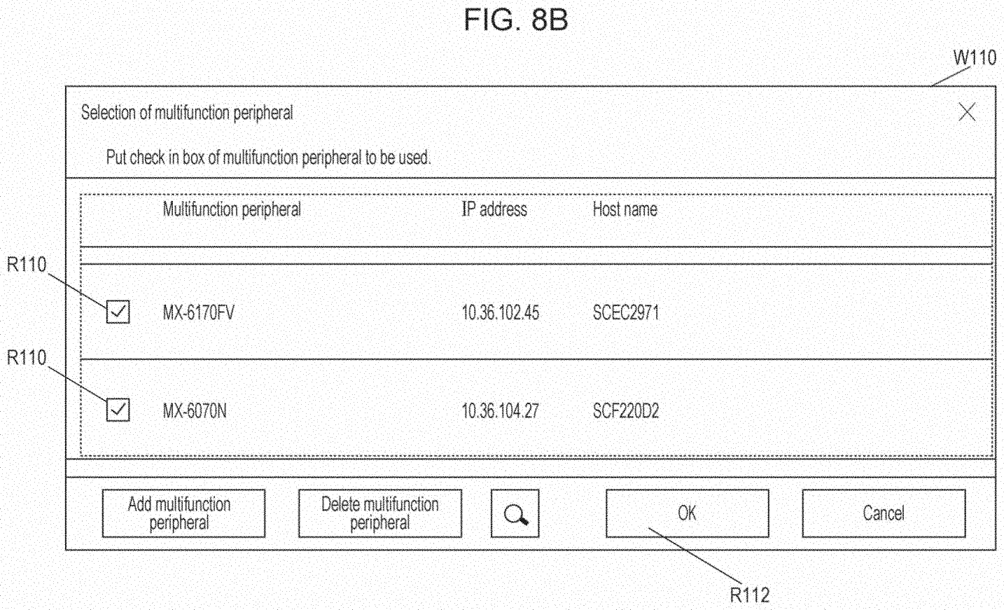

An operation example of this embodiment will be described below with reference to screen examples. FIG. 8A is a screen W100 representing an example of a display screen depicting an initial state of the file management process in this embodiment.

If “Selection of multifunction peripheral” displayed on R100 is selected (for example, touched) by the user, the multifunction-peripheral registration process is executed (Step S1002 in FIG. 5; Yes→Step S1004).

FIG. 8B is a screen W110 representing an example of a dialog in which the candidate list of the multifunction peripherals is registered. In FIG. 8B, information of the multifunction peripherals registered in Step 51110 of FIG. 6 is displayed in the form of a list. The model name, IP address, and host name of the multifunction peripheral are also displayed together in FIG. 8B. The multifunction peripheral to be registered into the multifunction peripheral tree is selected with checking in a check box (R110).

When “OK” displayed in R112 is selected by the user, the multifunction peripheral selected with checking in the check box is registered into the multifunction peripheral tree.

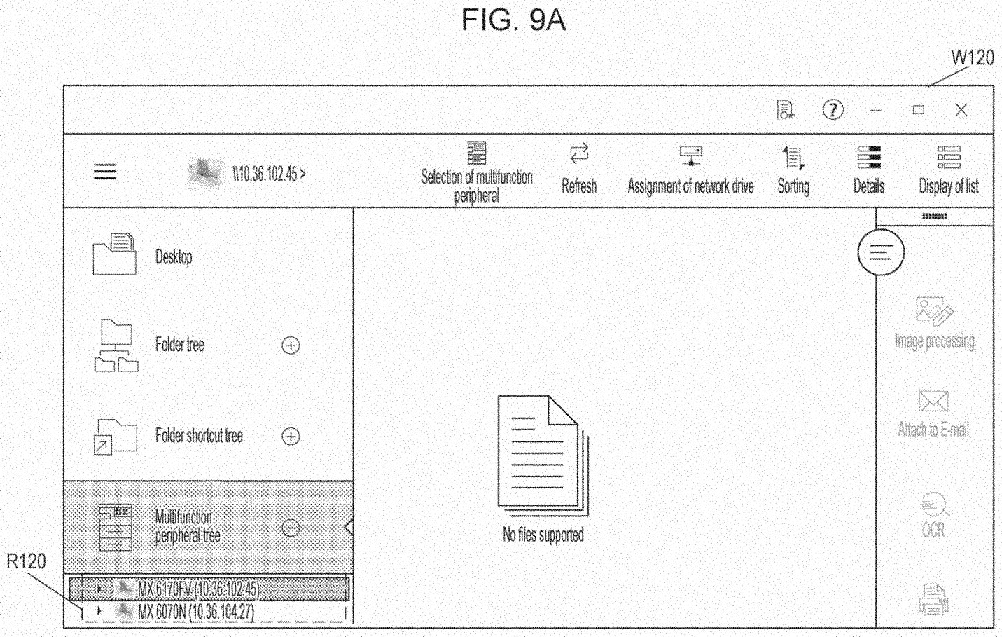

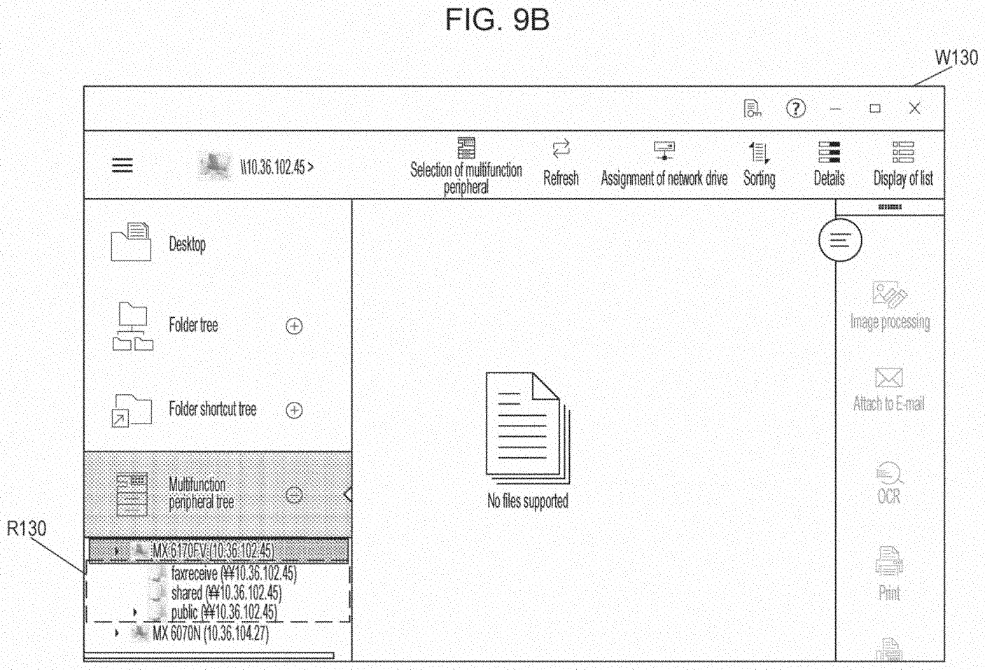

FIG. 9A is a screen W120 representing an example of a screen displaying the multifunction peripheral tree. On the screen W120, the multifunction peripheral tree is displayed in R120 (e.g., Step S1212 of FIG. 7). In the multifunction peripheral tree of FIG. 9A, the name and the IP address of the multifunction peripheral are displayed in a line.

Because the IP address is also displayed, the user can individually recognize, as different apparatuses, even the multifunction peripherals having the same model name. The IP address may be omitted.

FIG. 9B is a screen W130 representing an example of a screen displayed when one multifunction peripheral tree is selected in FIG. 9A. With selection of the multifunction peripheral “MX-6170FV”, for example, the shared folders “faxreceive”, “shared”, and “public”, which are accessible in the multifunction peripheral, are displayed.

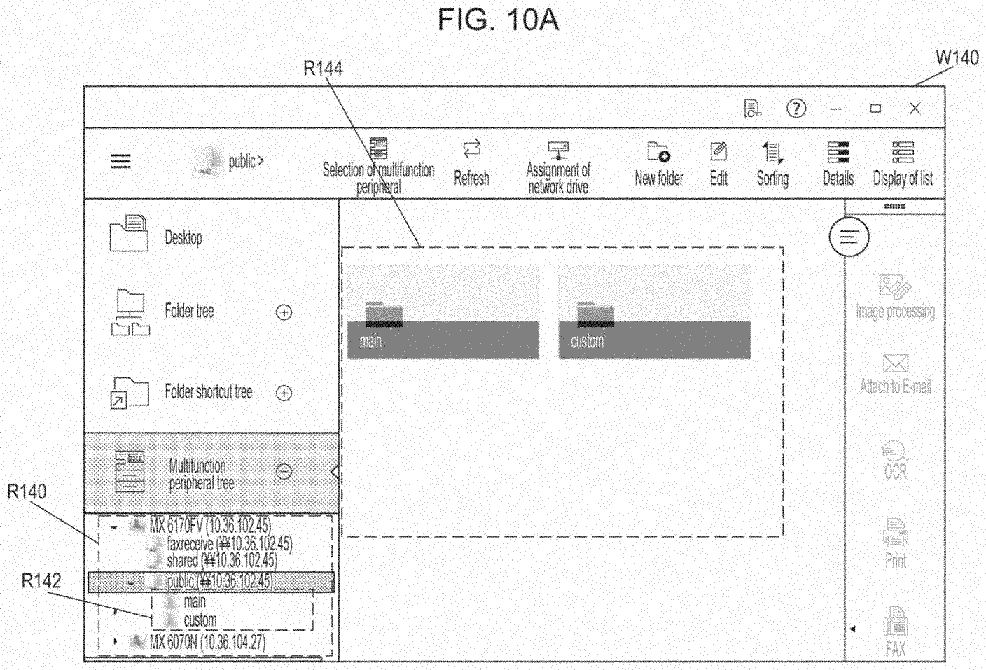

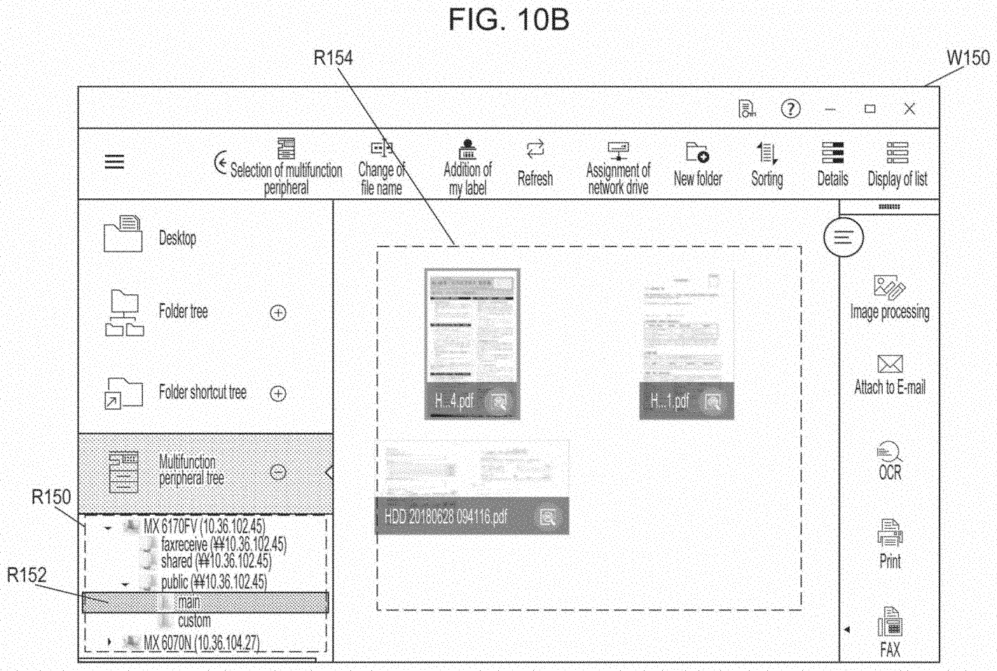

FIG. 10A illustrates a state in which one of the shared folders displayed in FIG. 9B is selected. On a screen W140 of FIG. 10A, the multifunction peripheral tree is displayed in R140, and one of the shared folders displayed in R140 is selected by the user.

Furthermore, folders (subfolders) included in the shared folder selected by the user are displayed in R142. list of those folders may be displayed with icons in a different area R144.

FIG. 10B illustrates a state in which one of the displayed folders (subfolders) is selected. On a screen W150 of FIG. 10B, the multifunction peripheral tree is displayed in R150 and one of the folders (subfolders) is selected in R152.

A list of files stored in the selected subfolder is displayed in R154. Previews of the files are displayed in R154, and the user can recognize what files are stored in the folder (subfolder).

By selecting one of the files displayed in R154, the user can display or print the selected file. Moreover, the user can copy or move the file by a drag and drop operation.

When no subfolders are present in the shared folder and only shared files are stored therein, a list of the shared files is displayed. When subfolders and shared files are both present in the shared folder, they are displayed together.

Thus, according to this embodiment, the user can register the multifunction peripheral, which provides the file sharing service, into the multifunction peripheral tree with a simple operation without obtaining the information of the multifunction peripheral to be registered.

In addition to the above-described method, the user can also register the multifunction peripheral 20 into the multifunction peripheral tree by directly inputting the information of the multifunction peripheral 20 (e.g., the IP address of the multifunction peripheral 20).

### 2. Second Embodiment

A second embodiment will be described below. The second embodiment is an embodiment in which various processes can be executed as the file processing executed by the file processor 104. A functional configuration and a processing flow in the second embodiment are the same as those in the first embodiment, and the following description is made about different points from the first embodiment.

The file processor 104 can execute various processes on the selected file. For example, the file processor 104 can perform the following processes.

### First Process

The file processor 104 executes a reprint process in accordance with an instruction from the user. More specifically, the user selects one of files stored in the shared file storage area 214 of the multifunction peripheral 20 and instructs reprint from a menu. The multifunction peripheral 20 reprints the selected file in accordance with the reprint instruction.

When printing is performed from the terminal apparatus 10, a printer driver adapted for the multifunction peripheral 20 is usually used. However, there is no necessity of installing the printer drive into the terminal apparatus 10 when printing is performed in accordance with the reprint instruction.

In general, the terminal apparatus 10 installs a printer driver for each of the makers or for each of the models of the multifunction peripherals 20. When printing the file, therefore, the user may falsely select the multifunction peripheral 20 as a print destination in some cases.

When the user gives the reprint instruction to the file stored in the shared file storage area 214 as described above, the multifunction peripheral 20 storing the relevant file prints it. Accordingly, the user does not mistake the print destination.

### Second Process

The file processor 104 executes a process of automatically copying part of the files stored in the shared folder upon receiving an access from the terminal apparatus 10.

Upon receiving an access to the shared folder in the multifunction peripheral 20 from the user, the file processor 104 automatically stores particular one among the files stored in the shared folder, i.e., the latest file or the file newly stored after the last access, in the file storage area 112 of the terminal apparatus 10.

As a result, the file corresponding to a document received by the multifunction peripheral 20 via FAX or the file scanned by the multifunction peripheral 20 can be automatically copied to the terminal apparatus 10 without resorting to spatial movement of the user.

On that occasion, the multifunction peripheral 20 may copy the file when a predetermined condition is satisfied. The predetermined condition may be, for example, a condition of copying only one or more files stored within 10 minutes from the time of receiving an access from the terminal apparatus 10, or a condition of allowing copying only when the terminal apparatus 10 is utilized by a predetermined user.

### Third Process

The file processor 104 performs user management and executes a process of displaying only one or more among the files stored in the shared file storage area 214 of the multifunction peripheral 20, which belong to the user of the terminal apparatus 10.

In the multifunction peripheral 20, for example, a document is read by the document reader 260 and is stored as image data in the storage 210. At that time, the image data is stored after adding user information that is obtained from information of the user logging in the multifunction peripheral 20. Here, the user information is added as meta-information or an attribute to the image data.

After accessing the shared folder in the multifunction peripheral 20, the terminal apparatus 10 displays, on a screen, a list of only files having the same user information as that of the user logging in the terminal apparatus 10 at that time, and does not display image data having attribute information of other users.

Alternatively, files belonging to other users maybe displayed in a grey-out mode such that execution of the file processing (such as displaying or printing those files) is not allowed.

In that case, the multifunction peripheral 20 reads a document and stores it as image data. However, the terminal apparatus 10 is not allowed to display image data belonging to another user. Accordingly, when some user scans a document and stores obtained image data in the shared file storage area 214, the stored image data can be kept from being viewed by other users.

### 3. Third Embodiment

A third embodiment will be described below. The third embodiment is an embodiment in which the terminal apparatus 10 does not manage the information of the multifunction peripheral 20. A functional configuration and a processing flow in the third embodiment are the same as those in the first embodiment, and the following description is made about different points from the first embodiment.

In the first embodiment, whether the multifunction peripheral is adapted for the file sharing service is determined by referring to the multifunction-peripheral management information on the basis of the obtained MIB value, and by specifying the model number of the relevant multifunction peripheral. On the other hand, in the third embodiment, the MIB obtained from the multifunction peripheral 20 contains information regarding service that can be provided by the multifunction peripheral 20. For example, information indicating that the multifunction peripheral 20 provides the file sharing service is contained in the MIB, specifically in an extended MIB.

If, when receiving the MIB, the information indicating that the multifunction peripheral 20 provides the file sharing service is contained in the extended MIB, the terminal apparatus 10 determines that the multifunction peripheral 20 provides the file sharing service.

Thus, according to the third embodiment, there is no necessity of referring to the management information for the multifunction peripheral 20 unlike the first embodiment.

### 4. Fourth Embodiment

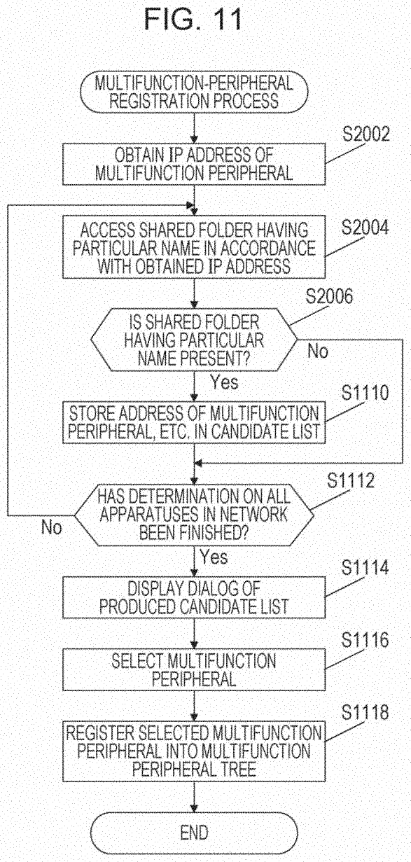

A fourth embodiment will be described below. The fourth embodiment is an embodiment in which the multifunction peripheral tree is produced depending on determination as to whether the terminal apparatus 10 can access the shared folder in the multifunction peripheral 20. A functional configuration and a processing flow in the fourth embodiment are the same as those in the first embodiment except for replacement of the processing flow of FIG. 6 in the first embodiment with the processing flow of FIG. 11, and the following description is made about different points from the first embodiment. Furthermore, the same processes as those in the first embodiment are denoted by the same reference signs and description of those processes is omitted.

First, the controller 100 (specifically, the file manager 102) obtains the IP address of the apparatus (multifunction peripheral) in the network (Step S2002).

In accordance with the obtained IP address, the controller 100 tries to access a shared folder having a particular name (i.e., a particular folder) (Step S2004). In this embodiment, there are three shared folders having particular names, i.e., “faxreceive”, “shared”, and “public”. The controller 100 may try to successively access those folders or to access only one of them. Thus, the controller 100 tries to access the shared folder having the predetermined folder name and determines whether the relevant shared folder is present.

If the shared folder having the predetermined folder name (i.e., the shared folder having the particular name) is present in the multifunction peripheral 20, it is determined that the multifunction peripheral 20 provides the file sharing service (Step S2006; Yes), and the address of the multifunction peripheral 20, etc. are stored in the candidate list together (Step S1110).

Thus, according to the fourth embodiment, even when the information indicating that the multifunction peripheral 20 can provide the file sharing service is not transmitted, the terminal apparatus 10 can register the multifunction peripheral 20 providing the file sharing service into the multifunction peripheral tree.

### 5. Modifications

Although the embodiments of the present disclosure have been described in detail above with reference to the drawings, concrete configurations are not limited to those explained in the embodiments, and designs, etc. modified within the scope not departing from the gist of the present disclosure also falls in the scope defined in Claims.

In the embodiments, the programs operating in the individual apparatuses are programs controlling an arithmetic apparatus such as a CPU (i.e., programs causing a computer to function) such that the above-described functions of the embodiments are implemented. Information handled by the individual apparatuses is temporality accumulated in a temporary storage (e.g., a RAM) during processing of the information, and then stored in various types of storages such as a ROM, a HHD, and an SSD. The stored information is read and is subject to correction and writing as appropriate by the CPU.

In the case of distributing the programs to the market, the programs can be distributed in a state stored in a portable recording medium, or transferred to a server computer connected via a network such as the Internet. In that case, a storage of the server computer also fails in the scope of the present disclosure.

The present disclosure contains subject matter related to that disclosed in Japanese Priority Patent Application JP 2018-165853 filed in the Japan Patent Office on Sep. 5, 2018, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising:
a communication device; and
a controller,
wherein the controller searches for image processing apparatuses in a network via the communication device,
specifies the image processing apparatus among the searched image processing apparatuses, the former image processing apparatus providing file sharing service, and
displays a list of file sharing folders in the specified image processing apparatus.

2. The information processing apparatuses according to claim 1, wherein, when one of the file sharing folders in the displayed list is selected, the controller displays a list of files stored in the selected file sharing folder.

3. The information processing apparatuses according to claim 1, wherein the controller searches for the image processing apparatuses in the network via the communication device by using an SNMP (Simple Network Management Protocol), and
the controller specifies the image processing apparatus providing the file sharing service in accordance with a MIB (Management Information Base) contained in a response from the image processing apparatuses.

4. The information processing apparatuses according to claim 1, further comprising a storage storing information of the MIB and information of the image processing apparatus in correspondence to each other,
wherein the controller specifies the image processing apparatus providing the file sharing service in accordance with the information stored in the storage.

5. The information processing apparatuses according to claim 1, wherein, when the controller is accessible to a folder having a particular name in the searched image processing apparatus, the controller specifies the searched image processing apparatus as the image processing apparatus providing the file sharing service.

6. A display method in an information processing apparatus equipped with a communication device, the display method comprising:
searching for image processing apparatuses in a network via the communication device,
specifying the image processing apparatus among the searched image processing apparatuses, the former image processing apparatus providing file sharing service, and
displaying a list of file sharing folders in the specified image processing apparatus.

7. A non-transitory recording medium storing a program in accordance with which a computer implements functions of:
searching for image processing apparatuses in a network,
specifying the image processing apparatus among the searched image processing apparatuses, the former image processing apparatus providing file sharing service, and
displaying a list of file sharing folders in the specified image processing apparatus.
